(19) United States
(12) Patent Application Publication
(10) Pub. No.: US 2003/0159053 A1
(43) Pub. Date: Aug. 21, 2003

(54) Secure reconfigurable input device with transaction card reader

(76) Inventors: Charles Fauble, Canyon Country, CA (US); Robert Dickerman, El Segundo, CA (US); Toshisada Takeda, Simi Valley, CA (US)

Correspondence Address: Mark R. Kendrick, PILLSBURY WINTHROP LLP, Suite 1200, 725 South Figueroa Street, Los Angeles, CA, 90017, US

(21) Appl. No.: 10/078,727

(22) Filed: Feb. 19, 2002

(51) Int. Cl. H04L 9/00

(52) U.S. Cl. 713/189

(57) ABSTRACT

A reconfigurable secure keyboard console receives an encryption key and at least one transformation instruction. The reconfigurable secure keyboard console stores the encryption key in a reconfigurable first memory. The reconfigurable secure keyboard console stores the at least one transformation instruction in a reconfigurable second memory. A keyboard processor utilizes the at least one transformation instruction to create a plurality of transformed codes. The plurality of transformed codes along with a plurality of values corresponding to each of the plurality of potential keyboard inputs are both stored in a transformed lookup table. The keyboard processor receives an actual keyboard input. The keyboard processor matches the actual keyboard input with one of the plurality of the potential keyboard inputs to create a matching value. The keyboard processor outputs a transformed code from the transformed lookup table corresponding to the matching value.

### BACKGROUND OF THE INVENTION

1. Field of the Invention

The present invention generally relates to secure communications utilizing an input device. More particularly, the present invention relates to a secure reconfigurable input device, such as a keyboard console, to be utilized in secure communications between computing systems.

2. Discussion of the Related Art

The growth of the Internet has led to a change in the way business is conducted. Consumers and businesses may purchase many products from web sites located on the Internet utilizing credit card or checking account information. A major concern has arisen regarding the security level of the Internet, specifically when sensitive personal or financial information is being transmitted from a consumer to a web site, e.g. a server hosting the web site. Sensitive personal and financial information may include credit-card information, social security numbers, bank-account information or privileged information.

The most popular form of computer security on the Internet is encryption. Encryption is the process of encoding information in such a way that only the person (or computer) with the key is able to decode it. Computer encryption is based on cryptography, which is coding messages. Computer encryption may fall into two categories: Symmetric-key encryption and public-key encryption. Symmetric-key encryption requires that each computer have a secret key. The secret key is used to decode the information transmitted between the two computers. In order for symmetric-key encryption to work, the secret key must be provided to each of the two computers. If this is done over a non-secure transmission line, the security of the secret key may be compromised and someone may be able to intercept the secret key.

Public-key encryption utilizes a combination of a private key and a public key. The public key is provided to any computer that wants to communicate securely with a central computer. The central computer also has a private key that is known only to the central computer. Note that if two-way communication is necessary, both computers may have a public key and a private key.

FIG. 1 illustrates the message flow of public-key encryption between computers according to the prior art. A first computing device contains a message in plaintext, e.g., a message that may be understood without any special measures. The first computing device utilizes the public key of the second computing device to encrypt the plaintext message into a ciphertext message, e.g., an encrypted message. The first computing device transmits the ciphertext message to the second computing device. The second computing device receives the ciphertext message and utilizes its private key to decrypt the ciphertext message and translate back into the plaintext message. The second computing device public key is only utilized to encrypt messages. The primary benefit of public-key encryption is that it allows people who have no pre-existing security arrangement to exchange messages securely.

The public keys and private keys are mathematically related; however, it is mathematically difficult to derive the private key given only the public key. It is possible to derive if enough computing power is utilized and enough time is provided. The larger the size of the public key, the more difficult it is to decipher. Industry standards are presently at 1024 bits, with some applications utilizing 2048 bits.

Another major benefit of public-key encryption is that digital signatures may be utilized by the two computing devices. A digital signature allows the recipient of the information to verify the authenticity of the information's origin. Plus, it allows the recipient to verify the information has not been altered in transit, e.g. verifying the integrity. Finally, it allows the recipient to have non-repudiation, e.g., the sender may not deny that the message was sent.

FIG. 2 illustrates the steps in the use of a digital signature between a first and second computing device according to the prior art. A first computing device has a plaintext message that is encrypted with the first device's private key and produces a signed message, e.g., digital signature. The signed message is transmitted from the first computing device to the second computing device. The second device utilizes the first computing device's public key to decrypt the signed message and verify that the first computing device originated the original message. The second computing device produces a verified message.

A problem arises in the use of digital signatures. A large volume of data is generated when encrypting a plaintext message with the private key because 1024 bits or 2048 bits may be used. A one-way hash function will allow less data to be generated. The one-way hash function takes variable-length input, e.g., a message with any bit length, and produces a fixed length output, i.e., 180 bits, that is unique for each individual variable-length input. If the message is changed in any fashion, an entirely different fixed length output value is produced (note the fixed length is 180 bits) for the changed message.

FIG. 3 illustrates a hashing function utilized along with a digital signature in a public-key encryption between two computing devices according to the prior art. The first computing device and the second computing device agree on the hash function to be utilized. The first computing device has a plaintext message it would like to transmit to a second computing device. The plaintext message is run through a hash function to shorten the number of bits and a hashed message is created. The hashed message is encrypted utilizing the private key of the first computing device to create an encrypted hash message. In addition, the plaintext message is encrypted utilizing the second computing device public key and a ciphertext message is created. The encrypted hash message is transmitted along with the ciphertext message to the second computing device with the encrypted hash message enabling a shorter and more manageable digital signature. The second computing device utilizes the first computing device's public key to decrypt the encrypted hash message, produce the hashed message and verify the origin of the message. The second computing device utilizes its private key to decrypt the ciphertext message and create a second plaintext message. In order to verify that the ciphertext message has not been altered in any way, the second computing device utilizes the shared hashing function to produce a second hashed message. The second hashed message is compared to the hashed message decrypted by the second computing device (the two messages should be equal in value) to verify that no alterations have been made. The slightest change to the signed document results in a failure of the hash verification.

Many systems utilize the combination of public-key encryption and symmetric encryption to increase security. Illustratively, secure communication between a first and second computing device may occur in the following manner. The first computing device and the second computing devices may exchange public keys, e.g., a first computing device public key is transmitted to the second computing device and the second computing device public key is transmitted to the first computing device. A device with a random number generator, normally the second computing device, may utilize the random number generator to generate a pseudo-random session key, which is a secret key. If the second computing device generates the secret key, the second computing device transmits the secret key to the first computing device utilizing public-key cryptography.

After the secret key is shared between the first computing device and second computing device, symmetric cryptography, using the secret key, is performed because the computational burden is lower on the system than with public key cryptography due to the smaller number of bits. In some cases, the public key is utilized only to share the secret key. In some systems, it may also be required that digital signatures are necessary during the transaction and hashing may be utilized in conjunction with the digital signatures. Also, in some secure environments, digitally-signed certificates may be utilized to establish each other's identity during the encrypted session. It is important to share digitally-signed certificates during the session because if the digitally-signed certificates are shared at the beginning, an attacker may sneak in and act like one or both of the parties and intercept communications.

A problem may arise when a hacker intercepts communication between the first computing device and the second computing device. Specifically, a hacker may intercept personal or confidential information by instructing one of the computing devices, normally the first computing device, to send the hacker unencrypted keyboard input. The hacker may accomplish this by installing a program on the first computing device that is attached to a “cookie” file. Alternatively, the hacker may also accomplish this by installing a program anywhere on the first computing device storage device or in the first computing device memory.

“Cookies” are pieces of data placed on a computer's hard drive by a web server, e.g., the second computing device. The “cookies” are stored in a first computing device storage device in a cookie file. “Cookies” are used for many different purposes with one of the most common purposes being the storage of a username and password for accessing the web site resident on the second computing device. “Cookies” may contain any type of information, person's preferences, favorite sites or other customizable information.

The hacker may send a “trojan horse” program to attach itself to “cookies” located on the first computing device storage device and transferred from a web site, e.g., second computing device. The “trojan horse” program is a program that looks inconsequential or irrelevant and later performs another function, in most cases a damaging function. For instance, if one logged onto the 1-800-Flowers web site and ordered flowers with a credit card, the 1-800-Flowers server may deposit a cookie on the user's computer with private or confidential information regarding the transaction. The hacker or third party may intercept the communication and attach a “trojan horse” program to the “cookie” as it is transmitted. The “trojan horse” program may then attach itself to the “cookie” file on the first computing device's storage device. Another way a “trojan horse” program may be deposited on a computer is if the hacker sends emails to a group of users offering a discount on product orders. If users open the email, the “trojan horse” program is activated and will attach itself to cookie files. When the “cookie” file is next activated, the “trojan horse” program springs into action.

This “trojan horse” program may initiate the next time the “cookie” is retrieved or the next time the consumer accesses the server from where the “cookie” was transmitted. The “trojan horse” program would allow the transaction to proceed normally between the first and second computing device over the Internet but also would instruct the first computing device to transmit the actual keystroke input along with the encrypted data to the hacker's computer. Because the hacker may see the actual keystroke input, the hacker would be able to copy the user's personal and financial information, such as personal identification numbers (PINs), passwords, and credit card information. The problem of a hacker intercepting actual keystroke input is not limited to a “trojan horse” program attaching itself to a “cookie file.” Any hacker-installed program resident on the first computing device storage device or in the first computing device memory may also intercept actual keyboard input and cause the same problem.

U.S. Pat. No. 6,056,193 to McAuliffe et al. discloses a computer keyboard console with an integral encoded device reader, which may for example be a smart code reader, which temporarily blocks communication between the computer keyboard console and host central processing unit by preferably disabling the host CPU when encoded data is input via the smart card reader and/or via keystrokers on the keyboard. A separate microprocessor in the keyboard console verifies the authenticity of the encoded information by comparing it to stored values in a memory and enables the central processing unit once the encoded data has been transmitted and verified. This invention prevents the keyboard from sending information stored on a smart card reader or input from the keyboard during the authentication process; however, the system provides no protection for confidential text messages, confidential financial information, and/or credit-card information when these messages and information are transmitted from the keyboard console of a first computing device to the second computing device.

Accordingly, a need exists to protect all information transmitted from a keyboard to a first computing device when the first computing device is engaging in secure communications with a second computing device.

### BRIEF DESCRIPTION OF THE DRAWINGS

FIG. 1 illustrates the message flow of public-key encryption between computers according to the prior art;

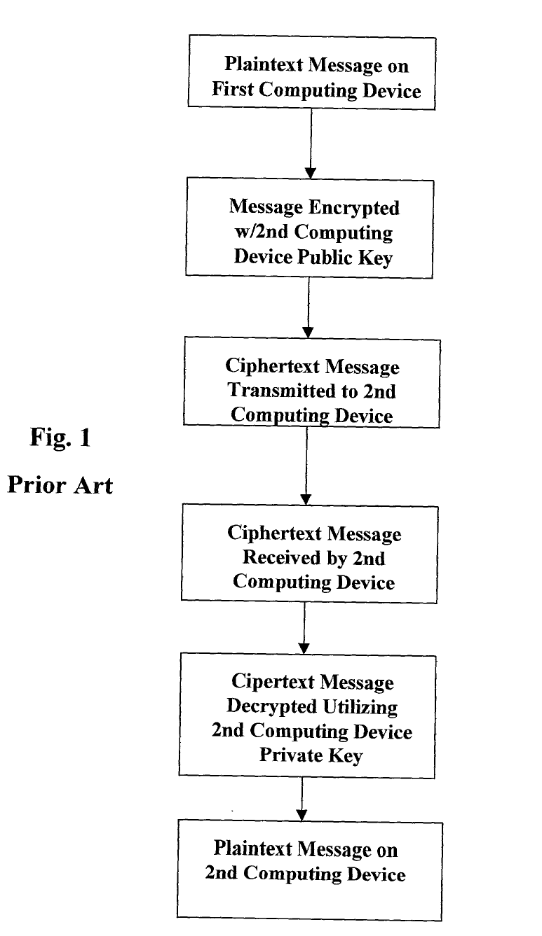

FIG. 2 illustrates the steps in the use of a digital signature between a first and second computing device according to the prior art;

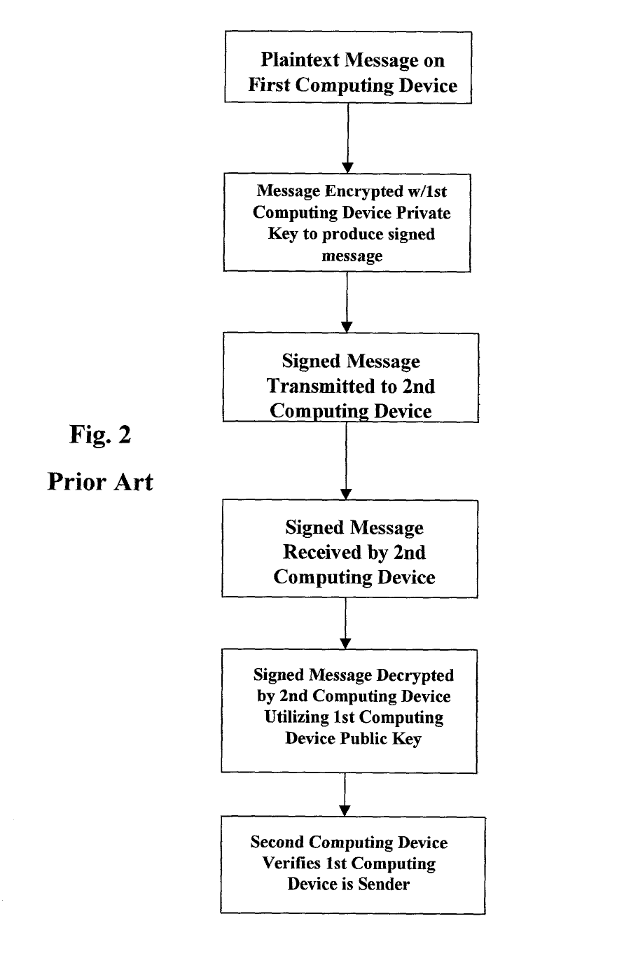

FIG. 3 illustrates a hashing function utilized along with a digital signature in a public-key encryption between two computing devices according to the prior art;

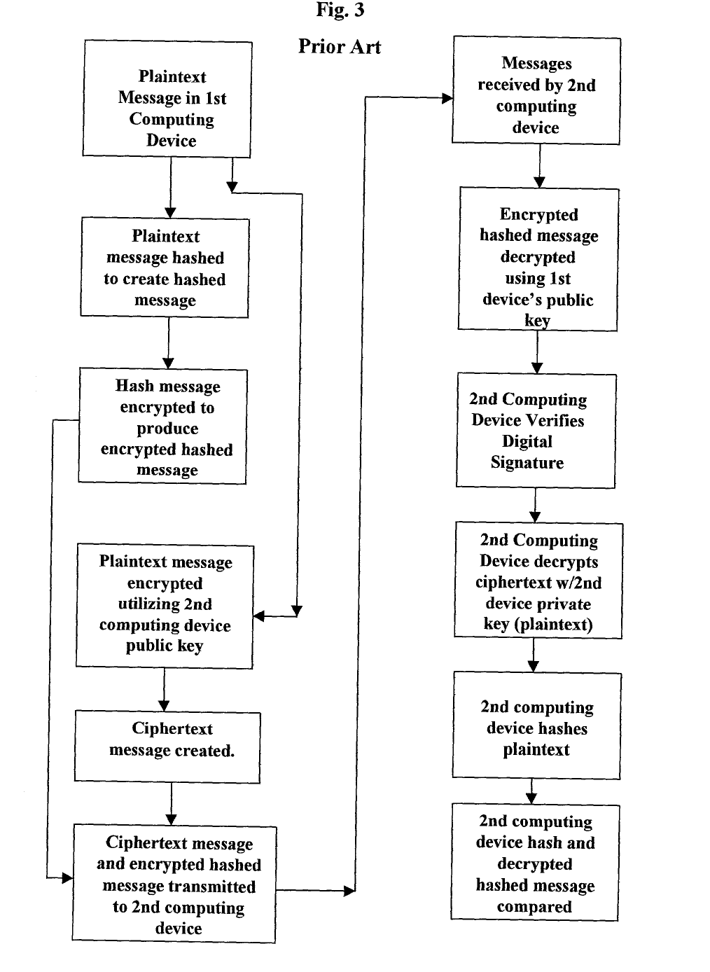

FIG. 4 illustrates a secure communication system according to one embodiment of the present invention;

FIG. 5 illustrates a reconfigurable secure keyboard console according to an embodiment of the present invention;

FIG. 6 illustrates a reconfigurable secure keyboard console with a transaction card device according to an embodiment of the present invention;

FIG. 7 illustrates an electronic payment application of the reconfigurable secure keyboard console in a secure communication system according to an embodiment of the present invention; and

FIG. 8 illustrates a dataflow diagram of a reconfigurable secure keyboard console of the present invention.

### DETAILED DESCRIPTION

A secure communication system may be established over a global network between at least a first computing device and a second computing device which includes additional security because all keyboard output is encrypted and because the second computing system may establish new codes for some or all potential keyboard inputs. In one embodiment of the present invention, the secure communication system may be utilized for conducting secure business transactions over the global network, e.g., an Internet. Keyboard input is not limited to input from a standard keyboard, such as the 84-key or 101-key keyboards. Illustratively, keyboard input may be received from a keypad, a numeric keypad, a game console, or a control button.

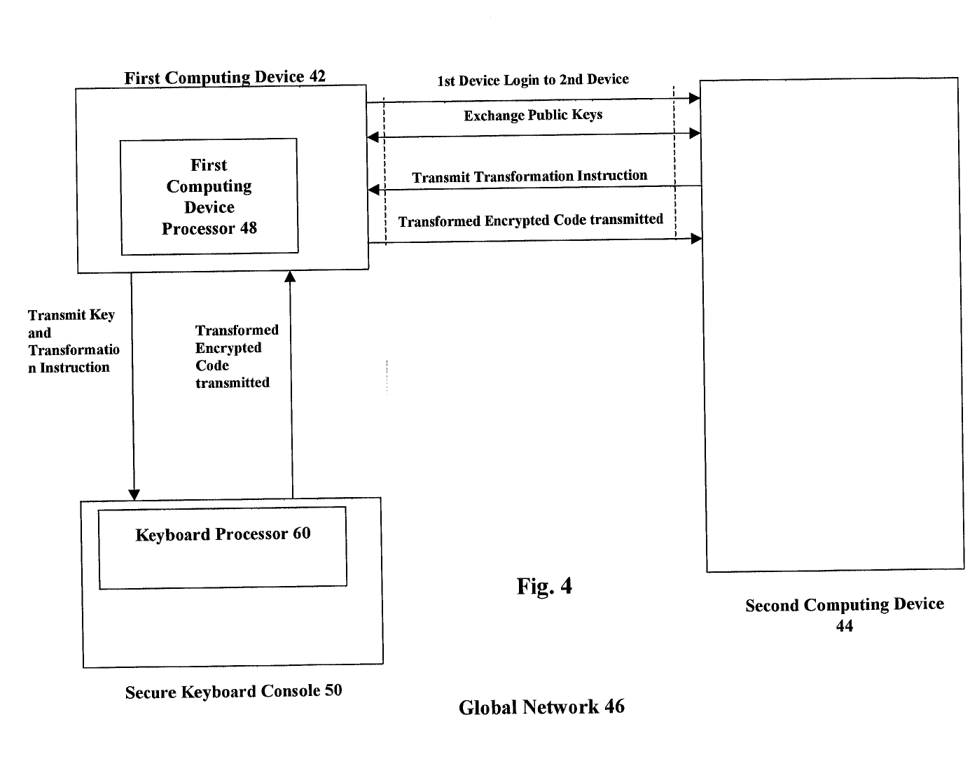

FIG. 4 illustrates operation of a secure communication system according to one embodiment of the present invention. The secure communication system 40 may include a first computing device 42, a second computing device 44, a global network 46, and a reconfigurable secure keyboard console 50. The reconfigurable secure keyboard console 50 may be attached to the first computing device 42 via a keyboard cable. In an alternative embodiment of the present invention, the reconfigurable secure keyboard console 50 may be included in the first computing device 42, e.g., when the first computing device is a laptop computing device. The reconfigurable secure keyboard console 50 may be a standard keyboard, e.g., 84-key keyboard or 101-key keyboard, a keypad, at least one control button, or a game console.

The secure communication system 40 may be established by the first computing device 42 logging into the second computing device 44 utilizing the global network 46. The first computing device 42 and the second computing device 44 may exchange public encryption keys. The second computing device 44 may then generate at least one transformation instruction, encrypt the at least one transformation instruction utilizing the first computing device public key, and transmit the encrypted at least one transformation instruction to the global network 46.

The first computing device 42 receives the second computing device public key and the encrypted at least one transformation instruction and may transfer the second computing device public key and the encrypted at least one transformation instruction to a reconfigurable secure keyboard console 50. The reconfigurable secure keyboard console 50 may store the second computing device public key in a memory located in the reconfigurable secure keyboard console 50. In one embodiment of the invention, the reconfigurable secure keyboard console processor may utilize the private key of the first computing device 42 to decrypt the at least one transformation instruction. In an alternative embodiment of the present invention, the first computing device processor 48 may decrypt the at least one transformation instruction before transferring the at least one transformation instruction to the reconfigurable secure keyboard console 50.

The at least one transformation instruction may be stored in a memory located in the reconfigurable secure keyboard console 50. The keyboard processor 60 may execute the at least one transformation instruction, and a plurality of codes which represent all of the potential keyboard input may be transformed into a plurality of transformed codes. The plurality of transformed codes are stored in a memory located in the reconfigurable secure keyboard console 50 along with a plurality of values which correspond to the all of the potential keyboard inputs.

In an embodiment of the present invention using a standard keyboard, actual keyboard input is then input into the reconfigurable secure keyboard console 50 via the depression of at least one key. The keyboard processor 60 accepts the actual keyboard input and determines one of the plurality of values which represent all of the potential keyboard input that corresponds to the actual keyboard input. The transformed code corresponding to the one of the plurality of values that corresponds to the actual keyboard input may be output and placed in a temporary buffer. The transformed code is then encrypted utilizing the second computing device public key and the encrypted transformed code is transferred from the reconfigurable secure keyboard console 50 to the first computing device 42. The first computing device 42 transfers the encrypted transformed code to the second computing device 44 via the global network 46. The second computing device 44 may receive the encrypted transformed code and decrypt the encrypted transformed code utilizing a second computing device private key. Because the second computing device 44 sent the at least one transformation instruction, the second computing device 44 can decode the transformation code and retrieve the actual keyboard input.

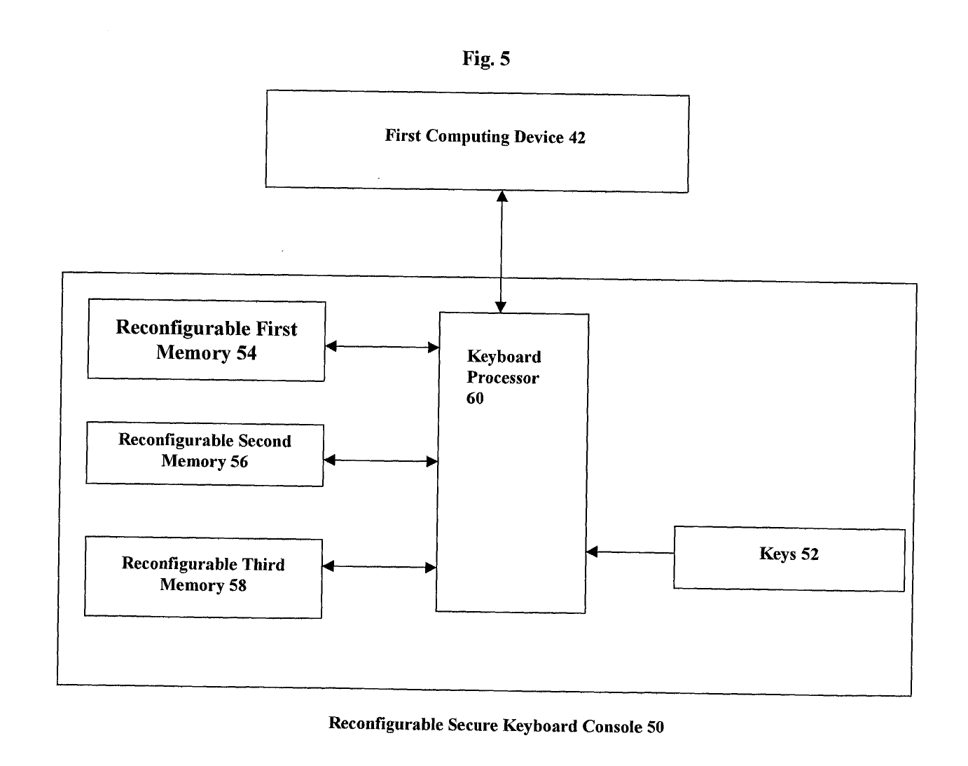

FIG. 5 illustrates a reconfigurable secure keyboard console 50 according to an embodiment of the present invention. In an embodiment of the present invention utilizing the standard keyboard, the reconfigurable secure keyboard console 50 may include a plurality of physical keys 52, a reconfigurable first memory 54, a reconfigurable second memory 56, a reconfigurable third memory 58, and a keyboard processor 60.

The reconfigurable first memory 54 may be utilized for storing an encryption key. The reconfigurable first memory 54 may contain one encryption key or may contain multiple encryption keys. The reconfigurable first memory 54 may only be written to or read by the keyboard processor 60. The encryption key may be a public key. Alternatively, the encryption key may be a private key or may be a hash value.

The reconfigurable second memory 56 may be utilized for storing at least one encryption instruction. The reconfigurable second memory 56 may contain multiple encryption instructions. Alternatively, the reconfigurable second memory 56 may contain at least one transformation instruction. In another embodiment of the present invention, the reconfigurable second memory 56 may contain multiple transformation instructions. In even another embodiment of the present invention, the reconfigurable second memory 56 may contain at least one encryption instruction and at least one transformation instruction. The reconfigurable second memory 56 may only be written to or read by the keyboard processor 60.

The reconfigurable third memory 58 may include a transformed lookup table. The structure and contents of the transformed lookup table are discussed below. The reconfigurable third memory 56 may only be written to or read by the keyboard processor 60.

In one embodiment of the present invention, the first reconfigurable memory 54 and the second reconfigurable memory 56 may be located in one physical memory. In another embodiment of the present invention, the first reconfigurable memory 54, the second reconfigurable memory 56, and the third reconfigurable memory 58 may be located in one physical memory. In an alternative embodiment of the present invention, any one of or any combination of the first configurable memory 54, the second configurable memory 56, and the third configurable memory 58 may be physically located in a memory card, where the memory card is located in a memory card reader attached to or installed in the reconfigurable secure keyboard console 50. These embodiments are merely illustrative and different combinations of configurable memories may be placed in different physical memory structures.

The keyboard processor 60 may include a standard lookup table. The processor 60 may be, for example, an Intel 8051 keyboard processor. The lookup table may include a plurality of codes representative of all of a plurality of potential keyboard inputs. The lookup table also may include values representative of all of the plurality of potential keyboard inputs. In an embodiment of the invention utilizing a standard keyboard, the plurality of potential keyboard inputs may be from a single key or may be from a combination of keys.

For example, a potential Universal Serial Bus (USB) hexidecimal coded keyboard input of “Ctrl-Alt-Del” may have a corresponding code of (“Ctrl” bit, “Alt” bit, 2A) and a corresponding key map location −15. The potential USB hexidecimal coded keyboard input of “a” may have the corresponding code of 04 and a corresponding key map location −31. The lookup table may include the two codes, e.g., 2A and 04, identified as the codes representative of the two potential keyboard inputs, “Ctrl-Alt-Del” and “a” along with the codes representative of all of the other potential keyboard inputs. In addition, the lookup table may include the values representative of the key map locations of “Ctrl-Alt-Del” and “a” along with the values representative of the key map locations of all of the other potential keyboard inputs.

The keyboard processor 60 may retrieve the at least one transformation instruction from the second reconfigurable memory 56 and execute the at least one transformation instruction. The execution of the transformation instruction enables the keyboard processor 60 to change some or all of the plurality of codes representative of the potential keyboard inputs. In one embodiment of the present invention, when the at least one transformation instruction is executed, a transformed lookup table may be created including the changed plurality of codes based on the transformation instruction. The changed plurality of codes may be referred to as transformed codes. In another embodiment of the present invention where multiple transformation instructions were retrieved from the second reconfigurable memory, the transformed lookup table may be created when the last of the multiple transformation instructions were executed. After the transformation instructions are executed and the transformed lookup table is created, the transformed lookup table may be stored in the third reconfigurable memory 58. The transformed lookup table may contain a plurality of values representative of all of the plurality of potential keyboard inputs and transformed codes representative of all of the plurality of potential keyboard inputs.

In an embodiment of the present invention utilizing a standard keyboard, after the transformed lookup table is created and stored in the third reconfigurable memory 58, the user may depress at least one of the plurality of keys 52. The at least one key 52 may create contact with a switch matrix which identifies the location of the depressed at least one depressed key in terms of a row and a column. The location in terms of a row and a column may be referred to as a value of one of potential keyboard inputs. Each of the locations of the at least one depressed key is equal to a value of one of the plurality of potential keyboard inputs. Thus, an actual keyboard input may be the location identified by the switch matrix of the actual single keystroke or combination of keystrokes. As discussed before, the standard lookup table and the transformed lookup table both include a plurality of values corresponding to the plurality of potential keyboard inputs. In alternative embodiments of the present invention not utilizing the standard keyboard, the keyboard input may be received from the keypad, the control button(s), or the game console.

The keyboard processor 60 may match the actual keyboard input to one of the plurality of values corresponding to one of the plurality of potential keyboard inputs located in the transformed lookup table. The keyboard processor 60 may then generate the transformed code located in the transformed lookup table corresponding to the actual keyboard input.

The keyboard processor 60 may retrieve the encryption key from the reconfigurable first memory 54. The keyboard processor 60 may retrieve the at least one encryption instruction from the reconfigurable second memory 56. The encryption instruction identifies what type of encryption is being utilized in the application currently utilizing the reconfigurable secure keyboard console 50. For example, the application may require symmetric encryption. The encryption instruction provides the information to the keyboard processor 50 to enable the keyboard processor 60 to encrypt the transformed codes in the requested fashion. For example, in the above case, the transformed code generated by the keyboard processor 60 may be symmetrically encrypted by the keyboard processor 60.

The reconfigurable first memory 54, the reconfigurable second memory 56, and the reconfigurable third memory 58 may be updated/reconfigured at any moment in time. For example, a second computing device 44 (see FIG. 4) interacting with a first computing device 42, which includes the reconfigurable secure keyboard console 50, may require the changing of an encryption key every 15 minutes. Another second computing device 44 may require changing the type of encryption required and the transformation of all of the potential keyboard inputs every two hours, therefore requiring the necessity of changing the at least one encryption instruction and the at least one transformation instruction. Therefore, the reconfigurable first memory 54 may receive and store a new encryption key and the reconfigurable second memory 56 may receive a new at least one transformation instruction and a new at least one encryption instruction.

In one embodiment of the present invention, the new encryption key may replace the first encryption key. In an alternative embodiment of the present invention, the new encryption key may be stored in the reconfigurable first memory 54 along with the first encryption key and the encryption instruction may identify which of the encryption keys to utilize. Similarly, the reconfigurable second memory 56 may also receive at least one new encryption and transformation instructions and the at least one new encryption and transformation instructions may be stored as the only encryption and transformation instructions in the reconfigurable second memory 56.

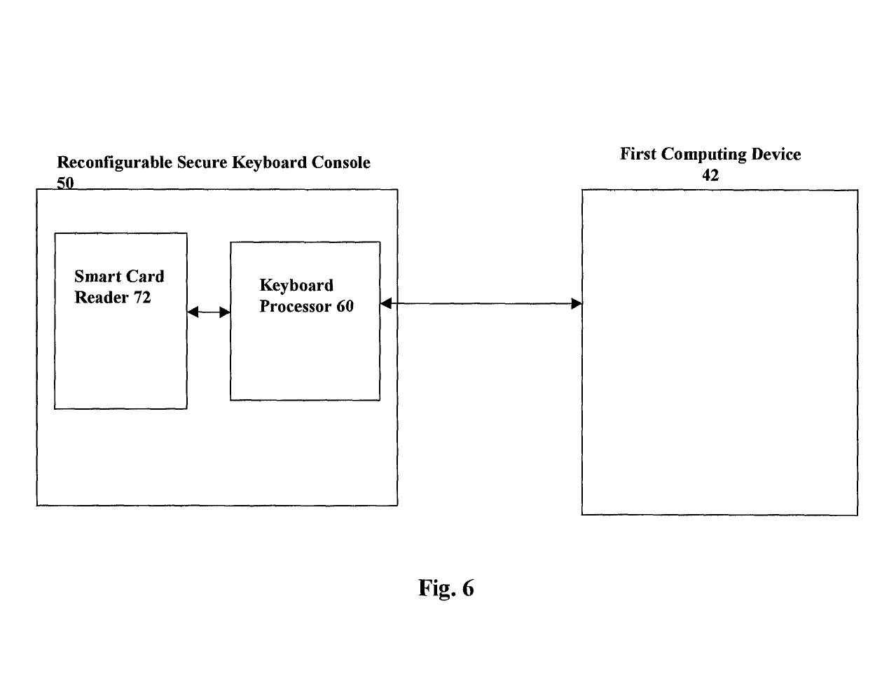

FIG. 6 illustrates a reconfigurable secure keyboard console with a transaction card device according to an embodiment of the present invention. The reconfigurable secure keyboard console 50 may include a transaction card device. The transaction card device may be a smart cart reader 72, a bar code reader, a memory card reader, or a biometric reader. In an embodiment of the present invention utilizing a smart card reader, a smart card may be inserted into the smart card reader. In an alternative embodiment of the invention, a subscriber identity module (SIM) may be inserted into the smart card reader.

In an embodiment of the present invention including a smart cart reader 72, the smart cart reader 72 may be installed inside the reconfigurable secure keyboard console 50. In order for a user to be able to utilize the reconfigurable secure keyboard console 50, the user must be able to match a unique identification number encoded on a smart card that may be inserted into the smart card reader 72. The user of a first computing device 42 may insert a smart card into a smart card reader 72, with the smart card containing the unique identification number encoded on the smart card. The unique identification number is read from the smart card, and transferred through from the smart cart reader 72 through a smart card interface of the reconfigurable secure keyboard console 50 to a secure memory location. The secure memory location may be inside the keyboard processor 60.

In an embodiment of the present invention utilizing a standard keyboard, after the smart card is inserted into the smart card reader 72, the user may utilize a combination of keys 52 on the reconfigurable secure keyboard console to replicate the unique identification number encoded on the smart card. In order to prevent the keyboard input produced by the user to be transferred to a first computing device external to the reconfigurable secure keyboard console 50, the keyboard processor 60 directs the keyboard input to the secure memory location for comparison with the unique identification number from the smart card. If the keyboard input matches the unique identification number from the smart card, then the user is allowed to start login to the first computing device 42. The keyboard processor 60 notifies the first computing device 42 that the user is authenticated by sending a verification message. The verification message may be encrypted by the keyboard processor 60, depending on the contents of the at least one encryption instruction. Alternatively, the verification may not be encrypted.

Once the user has been verified as authentic, the user may need to login to the operating system of the first computing device 42. The smart card may also contain the operating system login information. In an embodiment of the present invention where the first computing device 42 utilizes one of the Microsoft Windows operating systems, the smart card may contain the windows login information, e.g., a username and password. The Windows login information may be read from the smart card via the smart card reader 72 and brought into a temporary storage location in the reconfigurable secure keyboard console 50. A standard has been established for the encryption of login information, and it is included the personal computer/smart card (PC/SC) specification 1.0. In this embodiment of the invention, the Windows login information is encrypted according to the PC/SC 1.0 standard and transmitted out either a Universal Serial Bus (USB) or RS-232C interface to the first computing device 42. The first computing device 42 decrypts the Windows login information and verifies that the user is allowed access to the operating system on the first computing device. Once the Windows login information is verified, the user may run any applications, including logging onto the Internet to engage in secure transactions.

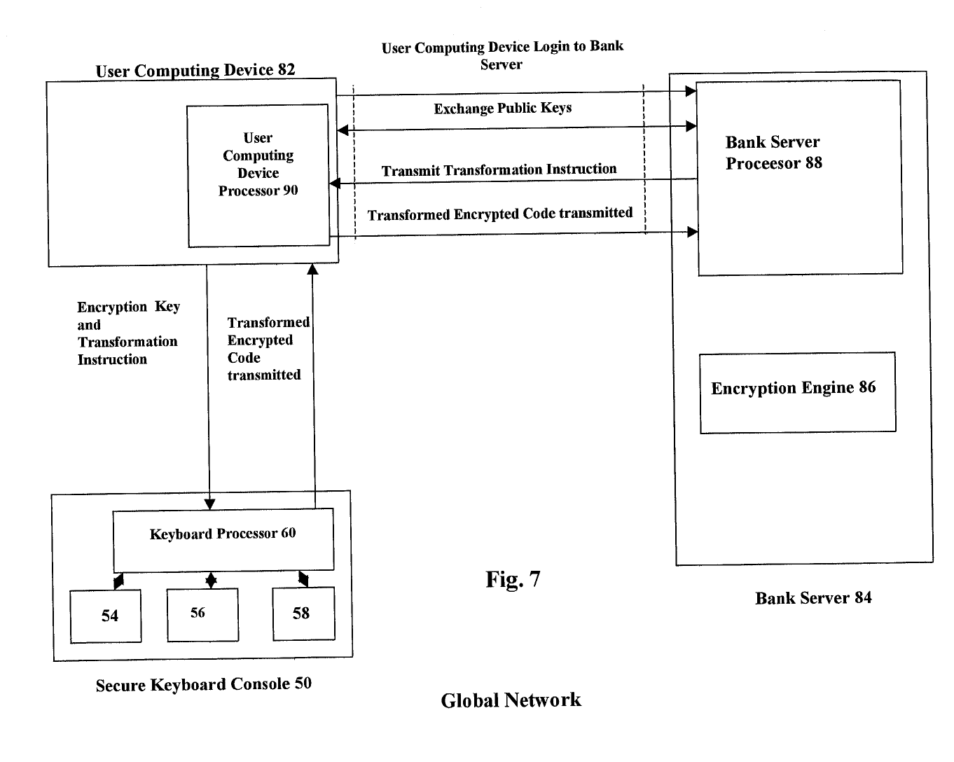

An embodiment of the present invention may be utilized in many different business environments to conduct secure business transactions. For example, an individual consumer may wish to submit an electronic payment to a bank over a global network like the Internet. FIG. 7 illustrates an electronic payment application of the reconfigurable secure keyboard console 50 in a secure communication system 80 according to an embodiment of the present invention. The electronic payment information consists of the user entering a checking account number, a social security number, a bank routing number and the payment amount through the reconfigurable secure keyboard console. By utilizing an embodiment of the present invention, the user may be protected from a hacker attaching a “trojan horse” program to the bank's “cookie” file on the first computing device storage device, and diverting the unencrypted data from the reconfigurable secure keyboard console 50 to his computer.

In one embodiment of the present invention, the user computing device 82 may send a confidential message input via the reconfigurable secure keyboard console 50, including the electronic payment information, over the Internet to the bank server 84. The bank server 84 may transform the codes corresponding to the plurality of potential keyboard inputs to a plurality of transformed codes corresponding to the plurality of potential keyboard inputs. Before sending the confidential message, the user computing device 82 must login to the bank server 84. The user computing device 82 and the bank server 84 may exchange public keys. Alternatively, the user computing device 82 may retrieve the bank server's public key from a publicly accessible location, e.g., the bank server web site and transfer the user computing device public key to the bank server 84. Because the bank server 84 may require the additional security of transforming the codes corresponding to the plurality of potential keyboard inputs, the bank server encryption engine 86 may generate a pseudo-random session key, which may be used later for symmetric encryption.

Public-key encryption may be used between the bank server 84 and the user computing device 82 to share the session key. Illustratively, the bank server 84 may encrypt the session key utilizing the user computing device public key and transmit the encrypted session key over the global network to the user computing device 82. The user computing device 82 decrypts the session key by utilizing the user computing device private key. The session key may be stored in a memory of the user computing device 82. The session key may also be transferred to the reconfigurable secure keyboard console 50 and stored in the first reconfigurable memory 54. Once the session key is decrypted, communications between the user computing device 82 and the bank server 84 may be symmetrically encrypted utilizing the session key.

The bank server may symmetrically encrypt the at least one transformation instruction by having the encryption engine 86 utilize the session key. The symmetrically encrypted at least one transformation instruction may be transferred to the bank server processor 88 and then to the user computing device 82 over the global network. The user computing device processor 90 may symmetrically decrypt the symmetrically encrypted at least one transformation instruction and transfer the at least one transformation instruction to the reconfigurable secure keyboard console 50. Alternatively, the user computing device processor 90 may transfer the symmetrically encrypted transformation instruction directly to the reconfigurable secure keyboard console 50 without attempting decryption in the user computing device 82. Because the reconfigurable secure keyboard console may have the session key already stored in the first reconfigurable memory 54, the keyboard processor 60 may utilize the session key to decrypt the at least one symmetrically encrypted transformation instruction within the reconfigurable secure keyboard console 50. Once the at least one symmetrically encrypted transformation instruction within the reconfigurable secure keyboard console 50 is decrypted, the at least one transformation instruction may be stored in a second reconfigurable memory 56.

The keyboard processor 60 may execute the at least one transformation instruction. The at least one transformation instruction identifies how the codes representative of all of the potential keyboard inputs may be transformed to meet the bank server's transformation requirements. The execution of the at least one transformation instruction creates the plurality of transformed codes, which are representative of all the potential keyboard inputs. The plurality of transformed codes and a plurality of values representative of all of the potential keyboard inputs may then be stored in the transformed lookup table, which may be located in the third reconfigurable memory 58. Because the at least one transformation instruction has been executed, any keyboard input from the reconfigurable secured keyboard console 50 may utilize the transformed lookup table and not the standard lookup table, which is located in the keyboard processor 60.

In an embodiment of the present invention utilizing the standard keyboard, the user of the user computing device may now enter the sensitive information (amount, bank routing number, etc.) by depressing the appropriate keys on the reconfigurable secure keyboard console 50. When each keyboard input is received, the keyboard processor 60 may match the actual keyboard input to a value in the transformed lookup table representative of that actual keyboard input. The keyboard processor 60 may then generate the transformed code representative of the keyboard input by using the transformed code corresponding to the value representative of the actual keyboard input. The transformed code representative of the actual keyboard input may be stored in a temporary buffer within the keyboard processor 60 until the temporary buffer receives enough transformed codes to fill the temporary buffer. In this embodiment of the present invention, the keyboard processor 60 may then utilize the session key, which is stored in the first reconfigurable memory 54, to encrypt the transformed codes from the temporary buffer. In an alternative embodiment of the present invention, the keyboard processor 60 may utilize the session key to symmetrically encrypt each transformed code directly after the transformed code has been generated.

The keyboard processor 60 may transmit the symmetrically encrypted transformed code(s) to the user computer device 82. In this embodiment of the present invention, the user computing device processor 90 may transfer the symmetrically encrypted transformed codes directly to the bank server 84 via the Internet. The bank server processor 88 and encryption engine 86 may utilize the session key to decrypt the symmetrically encrypted transformed codes, which results in the transformed codes being resident within the bank server 84. Because the bank server 84 provided the transformation instruction, the bank server processor 88 understands which of the potential keyboard inputs each of the transformed codes represents. Thus, the bank server processor 88 may be able to retrieve the confidential information from the user of the user computing device 82, e.g., account information, payment amount, bank routing number, etc., in a completely secure transmission and not worry about a hacker intercepting any of the data.

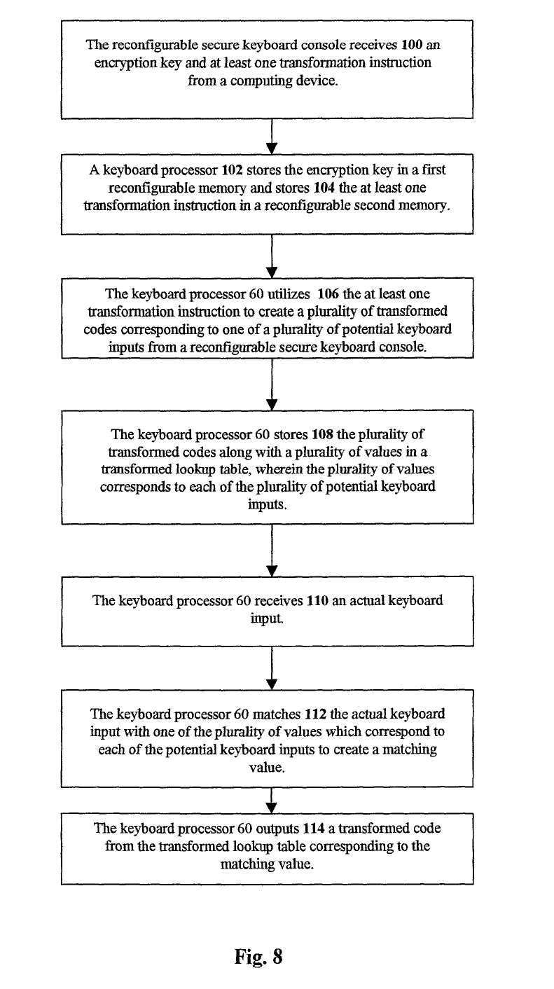

FIG. 8 illustrates a dataflow diagram of a reconfigurable secure keyboard console of the present invention. The reconfigurable secure keyboard console receives 100 an encryption key and at least one transformation instruction from a computing device. A keyboard processor 102 stores the encryption key in a first reconfigurable memory and stores 104 the at least one transformation instruction in a reconfigurable second memory. The keyboard processor utilizes 106 the at least one transformation instruction to create a plurality of transformed codes corresponding to one of a plurality of potential keyboard inputs from a reconfigurable secure keyboard console. The keyboard processor 60 stores 108 the plurality of transformed codes along with a plurality of values in a transformed lookup table, wherein the plurality of values corresponds to each of the plurality of potential keyboard inputs. The keyboard processor 60 receives 110 an actual keyboard input. The keyboard processor 60 matches 112 the actual keyboard input with one of the plurality of values which correspond to each of the potential keyboard inputs to create a matching value. The keyboard processor 60 outputs 114 a transformed code from the transformed lookup table corresponding to the matching value.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are intended to be embraced therein.

What is claimed is:

1. A reconfigurable secure keyboard console to encrypt a keystroke, comprising:
a plurality of physical keys;
a reconfigurable first memory to an encryption key;
a reconfigurable second memory to store at least one transformation instruction;
a reconfigurable third memory; and
a keyboard processor including a standard lookup table containing a plurality of codes and a plurality of values, each of the plurality of codes and the plurality of values corresponding to one of a plurality of potential keyboard inputs,
wherein the keyboard processor retrieves the at least one transformation instruction,
executes the at least one transformation instruction,
creates a transformed lookup table containing the plurality of values and a plurality of transformed codes, each of the plurality of values and the plurality of transformed codes corresponding to one of the plurality of potential keyboard inputs,
stores the transformed lookup table in the third reconfigurable memory,
receives actual keyboard input corresponding to one of the plurality of potential keyboard inputs and finds an actual value corresponding to one of the plurality of potential keyboard inputs;
matches the actual value with one of the plurality of values in the transformed lookup table; and
outputs a transformed code from the plurality of transformed codes corresponding to the actual value.

2. The reconfigurable secure keyboard console of claim 1, wherein the first reconfigurable memory and the second reconfigurable memory are both located in the same physical memory device.

3. The reconfigurable secure keyboard console of claim 1, wherein the first reconfigurable memory, the second reconfigurable memory and the third reconfigurable memory are located in the same physical memory device.

4. The reconfigurable secure keyboard console of claim 1, further including a transaction card reader.

5. The reconfigurable secure keyboard console of claim 4, wherein the transaction card reader is a smart card reader.

6. The reconfigurable secure keyboard console of claim 5, wherein a subscriber identity module (SIM) is plugged into the smart card reader

7. The reconfigurable secure keyboard console of claim 4, wherein the transaction card reader is a bar code reader.

8. The reconfigurable secure keyboard console of claim 4, wherein the transaction card reader is a biometric reader.

9. The reconfigurable secure keyboard console of claim 4, wherein the transaction card reader is a memory card reader.

10. A computing device, comprising:
a central processing unit (CPU);
a keyboard controller to receive encrypted data from the reconfigurable secure keyboard console; and
a reconfigurable secure keyboard console to transmit encrypted data to the keyboard controller including,
a plurality of physical keys,
a reconfigurable first memory to an encryption key,
a reconfigurable second memory to store at least one transformation instruction,
a reconfigurable third memory, and
a keyboard processor including a standard lookup table containing a plurality of codes and a plurality of values, each of the plurality of codes and the plurality of values corresponding to one of a plurality of potential keyboard inputs,
wherein the keyboard processor retrieves the at least one transformation instruction,
executes the at least one transformation instruction,
creates a transformed lookup table containing the plurality of values and a plurality of transformed codes, each of the plurality of values and the plurality of transformed codes corresponding to one of the plurality of potential keyboard inputs,
stores the transformed lookup table in the third reconfigurable memory,
receives actual keyboard input corresponding to one of the plurality of potential keyboard inputs and finds an actual value corresponding to one of the plurality of potential keyboard inputs,
matches the actual value with one of the plurality of values in the transformed lookup table, and
outputs a transformed code from the plurality of transformed codes corresponding to the actual value.

11. A secure computing system, comprising:
a global network;
a first computing device to communicate securely with a second computing device over the global network, including
a first central processing unit to receive encrypted information from the global network and to transmit encrypted information to the global network,
a reconfigurable secure keyboard console to transmit encrypted information and to receive encrypted information from the keyboard controller including
a plurality of physical keys,
a reconfigurable first memory to an encryption key,
a reconfigurable second memory to store at least one transformation instruction,
a reconfigurable third memory, and
a keyboard processor including a standard lookup table containing a plurality of codes and a plurality of values, each of the plurality of codes and the plurality of values corresponding to one of a plurality of potential keyboard inputs,
wherein the keyboard processor retrieves the at least one transformation instruction,
executes the at least one transformation instruction,
creates a transformed lookup table containing the plurality of values and a plurality of transformed codes, each of the plurality of values and the plurality of transformed codes corresponding to one of the plurality of potential keyboard inputs,
stores the transformed lookup table in the third reconfigurable memory,
receives actual keyboard input corresponding to one of the plurality of potential keyboard inputs and finds an actual value corresponding to one of the plurality of potential keyboard inputs,
matches the actual value with one of the plurality of values in the transformed lookup table, and
outputs a transformed code from the plurality of transformed codes corresponding to the actual value, and
a keyboard controller to receive encrypted information from the secure keyboard console and to output encrypted information to the first central processing unit, and
the second computing device communicates securely with the first computing device and includes
a central processing unit to receive encrypted information from the global network, transmit encrypted information to the global network, generate at least one transformation instruction, and
an encryption engine to generate encrypted information.

12. A method of encrypting keyboard input of a reconfigurable secure keyboard console, comprising:
receiving an encryption key and at least one transformation instruction from a computing device;
storing the encryption key in a reconfigurable first memory;
storing the at least one transformation instruction in a reconfigurable second memory;
utilizing the at least one transformation instruction to create a plurality of transformed codes, each of the plurality of encrypted transformed corresponding to one of a plurality of potential keyboard inputs from the reconfigurable secure keyboard console;
storing the plurality of transformed codes along with a plurality of values in a transformed lookup table, wherein the plurality of values corresponds to each of the plurality of potential keyboard inputs;
receiving an actual keyboard input;
matching the actual keyboard input with one of the plurality of the potential keyboard inputs to create a matching value; and
outputting a transformed code from the transformed lookup table corresponding to the matching value.

13. A program code storage device, comprising:
a machine-readable storage medium; and
machine-readable program code, stored on the machine-readable storage medium, the machine-readable program code having instructions to
receive an encryption key and at least one transformation from a computing device;
store the encryption key in a first reconfigurable memory;
store the at least one transformation instruction in a reconfigurable second memory;
utilize the at least one transformation instruction to create a plurality of transformed codes, each of the plurality of encrypted transformed corresponding to one of a plurality of potential keyboard inputs from a reconfigurable secure keyboard console;
store the plurality of transformed codes along with a plurality of values in a transformed lookup table, wherein the plurality of values corresponds to each of the plurality of potential keyboard inputs;
receive an actual keyboard input;
match the actual keyboard input with one of the plurality of the values which correspond to each of the potential keyboard inputs to create a matching value; and
output a transformed code from the transformed lookup table corresponding to the matching value.
